(19) United States
(12) Patent Application Publication
(10) Pub. No.: US 2009/0092718 A1
(43) Pub. Date: Apr. 9, 2009

(54) Ultra-high temperature oven for processing fish and seafood

(76) Inventors: Von T. Mendenhall, Athens, GA (US); J. Reeves Dahlstrom, Arvada, CO (US); Randy Loveland, Mendon, UT (US)

Correspondence Address: ALAN J. HOWARTH, P.O. BOX 1909, SANDY, UT, 84091-1909, US

(21) Appl. No.: 11/973,870

(22) Filed: Oct. 9, 2007

(51) Int. Cl. A23L 3/18; A23L 1/00; A47J 37/04; B65B 25/22; A23L 1/325

(52) U.S. Cl. 426/383; 426/393; 426/394; 426/416; 426/520; 426/521; 99/349; 99/351; 99/357; 99/443 C

(57) ABSTRACT

An oven and method of processing products such as fish and shellfish are disclosed. The oven may include a chamber that may be heated to ultra-high temperatures, such as within a range of about 600-2500° F. (315-1371° C.). A burner may heat the chamber from an exterior of the chamber such that the chamber may provide a uniform radiant heat inside the chamber. The products may be carried through the chamber on a conveyor belt to heat a surface of the products to brown and denature the surface, destroy microorganisms, and place grill marks on the products. The products may then be packaged in a microwavable package or boil-in-the-bag film such that the products may be cooked at a later time in a microwave oven or boiling water bath.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The present disclosure relates generally to devices and methods for processing food products, and more particularly, but not necessarily entirely, to devices and methods for treating the surface of fish and seafood.

It is common practice to display fresh food products without packaging at supermarkets. For example, fresh fish and shellfish are typically displayed in supermarket display cases for viewing by customers. Such practices may contribute to cross-contamination of the food products when handling practices and sanitation standards and conditions are not adequate. Moreover, fresh and refreshed (previously frozen) fish and shellfish exhibit a very short shelf-life of 2-3 days during refrigeration in the supermarket display case.

Packaged frozen fish and shellfish may have a longer shelf-life of 3-6 months, if the packaging is oxygen-impermeable to prevent deterioration of the flavor. Sales of frozen portions of food products are commonly not displayed due to the design of the display cases in the supermarkets and the packaging. Accordingly, consumers are often prevented from adequately visually inspecting frozen food products prior to purchase.

Also, there may be considerable uncertainty among consumers as to how to prepare and cook some food products such as fish and shellfish. This fact may contribute to the limited consumption of seafood in the U.S. diet, which is currently at about 17 pounds per person per year. Moreover, trends in cooking in U.S. households are focused on “heat and eat” technologies. These technologies require that many foods in the market be precooked. Consequently, the popularity of ready-to-eat items is increasing, and the presence of such items on the supermarket shelves is growing. Greater use of microwave energy to heat food products is occurring. Previously cooked foods, or “left-overs” are becoming a much greater portion of the diet of individuals residing in the U.S.

Fresh, refreshed, and frozen fish and shellfish cooked in a microwave oven may lose excess moisture and may have the appearance of being poached. Reheated, precooked fish and shellfish, prepared using the prior methods, may exhibit the undesirable quality of “left-overs” that have been cooked a second time.

Considerable time and money is expended in restaurants for browning foods such as fish to enhance visual presentation and improve flavor. These practices may require skilled cooks and quality time to insure consistent, uniform results. Cooking frozen fish and shellfish, without first thawing the portion is a common practice that results in a drier texture when compared to fresh fish cooked by the same method.

Restaurants and other food service establishments want food servings having uniform portions. Other desirable attributes of food products include food products that require minimal preparation and can be cooked in a relatively short period of time with a minimal cooking skill requirement. Also, there is a need for food products that result in a presentation to the customer that meets or exceeds their expectations. Greater utilization of semi-skilled labor, reduced preparation time, and the implementation of cooking methods that minimize variability and insure consistency all contribute to an economic benefit and competitive advantage to an establishment.

Despite the advantages of known methods and devices for treating food products such as fish and seafood, improvements are still being sought. The prior art is characterized by several disadvantages that are addressed by the present disclosure. The present disclosure minimizes, and in some aspects eliminates, the above-mentioned failures, and other problems, by utilizing the methods and structural features described herein.

The features and advantages of the disclosure will be set forth in the description that follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE SEVERAL VIEW OF THE DRAWINGS

FIG. 1 is a schematic side cross-sectional view of an oven useful in accordance with the principles of the present disclosure.

FIG. 2 is a schematic top cross-sectional view of the oven of FIG. 1.

FIG. 3 is a schematic end cross-sectional view of the oven of FIG. 1.

FIG. 4 is a schematic side cross-sectional view of an alternative embodiment oven.

FIG. 5 is a flow chart depicting exemplary steps of a method useful in accordance with the principles of the present disclosure.

FIG. 6 is a flow chart depicting additional exemplary steps of a method useful in accordance with the principles of the present disclosure.

### DETAILED DESCRIPTION

For the purposes of promoting an understanding of the principles in accordance with the disclosure, reference will now be made to the embodiments illustrated in the drawings and specific language will be used to describe them. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present apparatus and methods for processing food products are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

It must be noted that, as used in this specification and the appended claims, the singular forms “a,” “an,” and “the” include plural referents unless the context clearly dictates otherwise. Moreover, as used herein, the terms “comprising,” “including,” “containing,” “characterized by,” and grammatical equivalents thereof are inclusive or open-ended terms that do not exclude additional, unrecited elements or method steps.

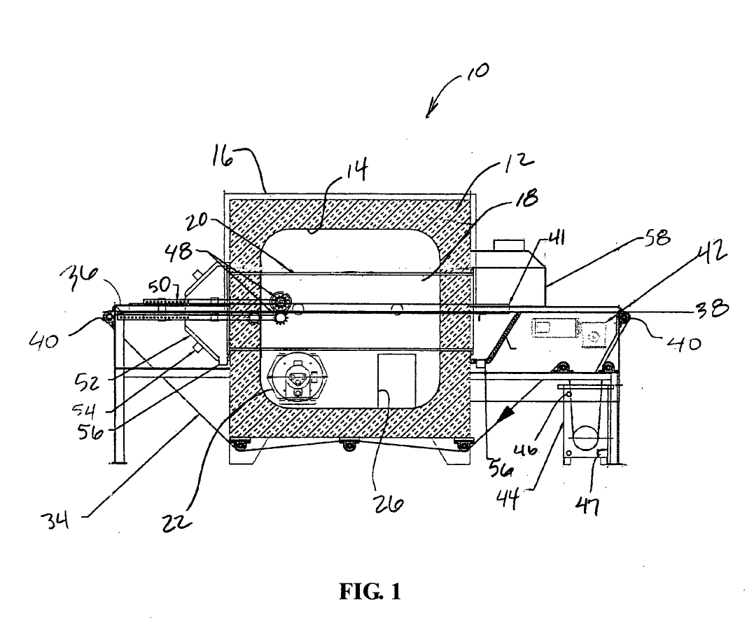

Referring now to FIG. 1. a side cross-sectional view is shown of an oven, indicated generally at 10. The oven 10 may include a housing 12 for defining an enclosed space 14 for receiving items such as food products to be heated. It will be understood that the oven 10 may be used to process any variety of food products, including fish and shellfish, in accordance with the principles of the present disclosure. It will also be understood that some embodiments of the oven 10 may be used to process non-food products.

The housing 12 may be formed in various different sizes and configurations suitable for the items intended to be heated. One embodiment of the housing 12 may include an insulation material to assist in maintaining a high temperature within the enclosed space 14. It will be understood that the insulation material may be formed of any suitable material known in the art, such as fiberglass mineral wool, synthetic fiber, ceramic, and the like. One embodiment of the oven 10 may include an 8 inch insulated wool layer covered by a heat shield 16. However, it will be understood that any different suitable dimension and material may be used in accordance with the principles of the present disclosure.

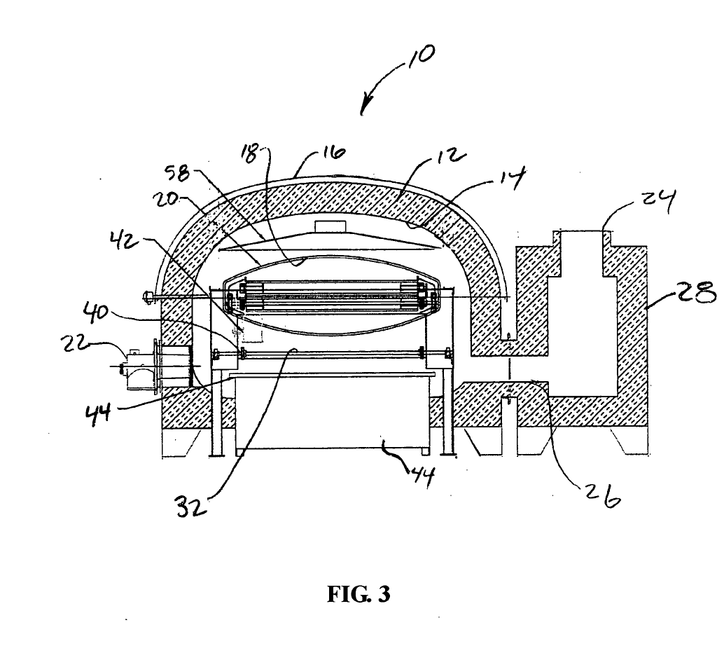

The oven 10 may also include a chamber 18. The chamber 18 may include a chamber wall 20 that may be configured to pass through the housing 12 and the enclosed space 14. The chamber wall 20 may be formed of a heat conducting material, such as metal, that may be configured to separate the space inside the chamber 18 from the remainder of the enclosed space 14. Moreover, heat generated in the enclosed space 14 outside of the chamber 18 may be conducted within the chamber 18. Accordingly, the chamber 18 may define a space to be heated for receiving items, such as food products. One embodiment of the chamber 18 may form a hot zone that may be sized approximately 42 by 48 inches (1 by 1.2 meters), for example. It will be understood that the chamber 18 may have any suitable size or configuration within the scope of the present disclosure. For example, the chamber 18 may have curved upper and lower walls and substantially straight sidewalls, as shown in the end view of the chamber 18 in FIG. 3. Alternatively, an end view of the chamber 18 may have a round, oval, rectangular, or any other suitable configuration.

The oven 10 may also include a heat source 22. The heat source 22 may include a burner for burning a combustible gas to generate heat in a manner known to those skilled in the art. It will be understood that other embodiments of the present disclosure may include heat sources of other varieties, such as electrical elements, for example. The heat source 22 may be positioned inside the enclosed space 14 on an exterior of the chamber 18. Accordingly, heat generated by the heat source 22 may envelop the chamber 18 to heat the chamber wall 20 and thereby provide uniform radiant heat within the chamber 18. Due to the separation of the chamber 18 from the remainder of the enclosed space 14, products inside the chamber 18 may not come into direct contact with the heat source 22. It will be understood that other embodiments of the present disclosure may have different quantities of heat sources, and the heat sources may be positioned in different locations within the scope of the present disclosure.

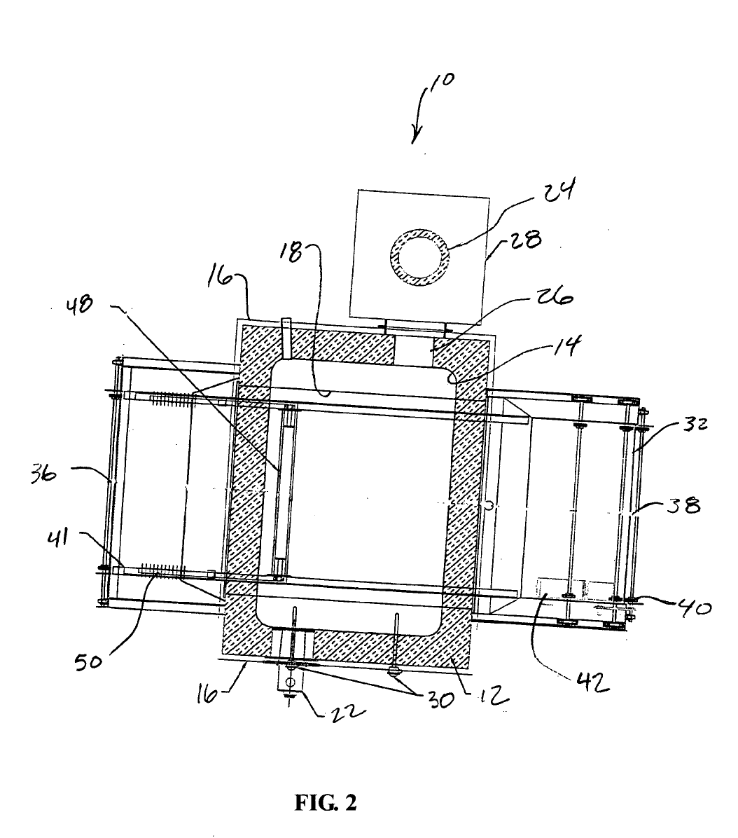

Referring to FIG. 2, which shows a top view of the oven 10, heat and combusted gas from the heat source 22 may travel from the heat source 22 across to the opposite side of the oven 10 to an exhaust port 24. The exhaust port 24 may include any variety of conduit or outlet 26 for transporting exhaust from within the enclosed space 14 to the environment outside of the oven 10. The outlet 26 may be positioned on a lower portion of the enclosed space to assist in circulating heat around the chamber 18, since the heat would tend to rise in the enclosed space 14. One embodiment of the exhaust port 24 may include a outlet conduit 26 leading to a chimney 28, as best shown in the end view of the oven 10 depicted in FIG. 3. Accordingly, the exhaust port 24 may be configured for directing the hot gases in an upward direction out of the chamber 18. The chimney 28 and outlet conduit 26 may be configured and insulated in any suitable manner known to those skilled in the art.

Referring again to FIG. 2, the oven may include one or more thermocouples 30 for assisting in controlling the temperature inside the enclosed space 14. It will be understood that the thermocouples 30 may be used to determine the temperature inside the enclosed space 14 and to send a signal to a control panel (not shown) to control the heat source 22 to either increase or decrease the heat added to the enclosed space 14. It will be understood that any other suitable temperature control mechanism may be used with the oven 10 in accordance with the principles of the present disclosure.

It will be understood that heat source 22 may thus be configured to provide ultra-high temperatures within the oven 10. As used herein, the phrase “ultra-high temperature” shall be construed to include temperatures in the range of approximately 600-2500° F. (315-1371° C.). It will be understood that the oven 10 may be used to achieve various different temperatures within the scope of the present disclosure, and that oven temperatures can be controlled by a thermostat so that a constant temperature can be maintained at any desired level.

The oven 10 may also include a conveyor 32 for transporting items through the oven 10. The conveyor 32 may include a belt 34 that may be arranged to make a continuous path from an entrance 36 to an exit 38 of the oven 10. The belt 34 may include a flexible member, such as a chain-like configuration of a plurality of spaced apart members connected together for supporting the items and being moved with a plurality of movement members 40, such as sprockets, pulleys, or the like. A guide or guides 41 may be provided to maintain the belt 34 in position in a manner known to those skilled in the art.

A motor 42, such as an electric drive motor or the like, may be provided to drive the belt 34 in a continuous movement path. It will be understood that any variety of motor known to those skilled in the art may be used within the scope of the present disclosure, such as a direct current or alternating current motor, and that some embodiments of the present disclosure may include manual drive mechanisms without, or in addition to, a motor 42. One embodiment of the motor 42 may be operated at variable speeds to increase or decrease the speed of the conveyor 32 to vary the retention time of products within the chamber 18. For example, one embodiment may be configured to process approximately 900 pounds of product per hour. Similarly, the motor 42 may be stopped and started to position items within the chamber 18, and to transport the items out of the chamber 18 as desired. One embodiment of the motor 42 may be used to drive a movement member 40 in a rotational manner to thereby cause the belt 34 to move.

The oven 10 may also include a tank 44, also sometimes referred to as a quench tank, for receiving a cleaning liquid, such as water, for cleaning and/or cooling the belt 34. The belt 34 may be routed through the tank 44 such that the belt 34 may be continuously cleaned during operation of the oven 10. Items treated in the oven 10 such as skinned fish and shellfish, may tend to stick to the belt 34. Sticking may be noticeably worse when the fish is glazed or contains a coating. When the belt 34 is cleaned immediately after exiting the oven chamber 18, and then reheated, the belt may be effective in significantly reducing sticking.

One embodiment of the tank may also include one or more brushes 46 for contacting the belt 34 and further cleaning the belt 34. The brushes 46 may be formed of stainless steel, for example, or any other material and configuration known in the art for contacting the belt 34 to remove debris. It will be understood that the tank 44 may include a drain such that the liquid in the tank 44 may be drained and clean liquid may be added as necessary. It will also be understood that any variety of cleaning agent or non-sticking agent may also be added to the tank 44. Other embodiments of the oven 10 may be provided without a tank 44.

One embodiment of the oven 10 may also include a sonic cleaner, shown schematically at 47, such as a sonic water bath for use with the tank 44 to clean the belt 34. It will be understood that the sonic cleaner 47 may be formed as any suitable sonic cleaning device known to those skilled in the art. The sonic cleaner 47 may be used to create vibrations in the tank 44 to provide additional cleaning capabilities to the tank 44. It will be understood that some embodiments of the oven 10 may be formed without the sonic cleaner 47, and that other embodiments may use other cleaning mechanisms known to those skilled in the art. For example the belt 34 may be formed or coated with a material that prevents sticking.

The oven 10 may also include one or more branders 48 for placing grill marks on the products in the oven 10. The branders may include a plurality of rods or ribs configured to contact the products in the oven 10 to heat the products to place grill marks and a charcoal flavor on the products. One embodiment of the present disclosure may include branders 48 on both the top and bottom of the belt 34 to contact the products. The branders 48 may be formed in an elongate wheel extending across the belt 34 to roll across the product and place grill marks on the product as the branders 48 contact the products. The brander 48 beneath the belt 34 may extend between gaps in the belt 34 to thereby contact the product to place the grill marks. Alternatively, the grill marks may be placed on the products by the belt 34 itself. Accordingly, grill marks may be placed on both the top and bottom of the products.

The branders 48 may be positioned inside the chamber 18 such that the branders 48 may be heated by the heat source 22. Since the branders 48 may remain in the chamber 18, the branders 48 may remain in a heated condition to place the grill marks on the products. One embodiment of the oven 10 may include branders 48 that may be adjustable in position towards the entrance 36 of the oven 10, such that the temperature of the branders 48 may be modified by adjusting a position of the branders 48 in the chamber 18. A schematic depiction of a brander adjustment mechanism 50 is depicted in FIGS. 1 and 2. The branders 48 may be maintained at a higher temperature when they are positioned further into the chamber 18 such that more intense grill marks may be accomplished. When lighter grill marks are desired on the products, a position of the branders 48 may be adjusted toward the entrance 36 such that the branders 48 may be provided at a cooler temperature. It will be understood that any variety of adjustment mechanisms known in the art may be used to move the branders 48 in accordance with the principles of the present disclosure. For example, the branders 48 may be positioned on a bracket that may be accessed and moved from a location on an exterior of the oven 10. It will also be understood that a height of the branders 48 may be adjustable to accommodate products having different thicknesses.

In one embodiment of the present disclosure, movement of the products by the conveyor 32 may cause the branders 48 to roll or rotate to thereby place the grill marks on the products. It will be understood that other embodiments of the oven 10 may include branders that operate in a different manner, such as an additional branding conveyor positioned on top of the conveyor 32, or branders with motors dedicated to driving the branders, or branders configured as rods extending in a direction along the movement path of the conveyor 32. Moreover, alternative embodiments of the present disclosure may be provided without a brander.

One embodiment of the oven 10 may include an air plenum 52 near the entrance 36 of the oven 10. The air plenum 52 may be formed in a manner known in the art and provided to move air into the chamber 18 to prevent excess heat from traveling from the chamber 18 toward the entrance 36. An air inlet 54 may also be provided such that the air pressure and heat in the chamber 18 may be maintained as product is introduce into the chamber 18.

It will be understood that the oven 10 may also include one or more drains 56 to facilitate cleaning the oven 10. Drains 56 may be positioned at various different locations, such as near the entrance 36 and exit 38 of the oven 10. Accordingly, the oven 10 may be cleaned with water or steam, and water and debris may be removed through the drains 56. It will be understood that the quantity, location and configuration of the drains 56 may vary within the scope of the present disclosure.

One embodiment of the oven 10 may include a hood 58 on a portion of the oven 10 near the exit 38. The hood 58 may be configured to capture fumes exiting from the chamber 18. It will be understood that the plenum 52 and the hood 58 may direct the flow of heat and fumes from the chamber 18 in a direction from the entrance 36 toward the exit 38 of the oven 10. The hood 58 may also include any variety of filters, fans, or conduits to channel or treat the fumes in a manner known to those skilled in the art. One embodiment of the hood 58 may be removable, movable, or slidable to be positioned as desired to facilitate use or cleaning of the oven 10. It will be understood that other embodiments of the hood 58 may be fixedly attached, and some alternative embodiments of the oven 10 may be formed without the hood 58.

One embodiment of the oven 10 may include the conveyor 32 configured to pass the belt 34 through the chamber 18 carrying products from the entrance 36 to the exit 38. As the belt 34 exits the chamber, the belt may be heated, such as to a temperature of approximately 650° F. (345° C.), for example. The belt 34 may pass on an underside of the oven 10 from the exit 38 toward the entrance 36. As the belt 34 passes through the tank 44, the belt 34 may be cooled so as to prevent sticking of products on the belt 34. Accordingly, the products may be placed on the belt 34 when the belt is in a cooled condition.

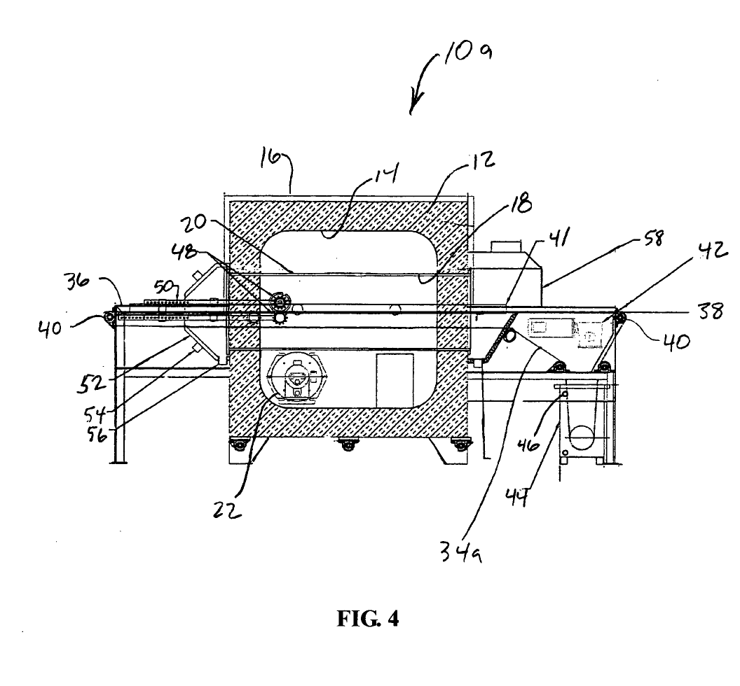

Alternatively, as shown in FIG. 4, the belt 34a may be routed from the tank 44 back into the chamber 18 such that the belt 34a may be pre-heated prior to arriving at the entrance 36. Such pre-heating of the belt may improve the heating of the products and may prevent sticking. Moreover, embodiments with pre-heated belt 34 may be used to place grill marks on the products on the bottom of the products, thereby eliminating the need for a brander to place grill marks on the bottom of the products. It will be understood that the oven 10 may be configured such that the belt 34 may be routed in various different configurations to pre-heat the belt 34 or avoid pre-heating the belt 34.

It will be understood that the oven 10 and the components of the oven 10 may be manufactured using techniques known to those skilled in the art. Moreover, any suitable material known to those skilled in the art may be used to form the components of the oven 10 in accordance with the principles of the present disclosure.

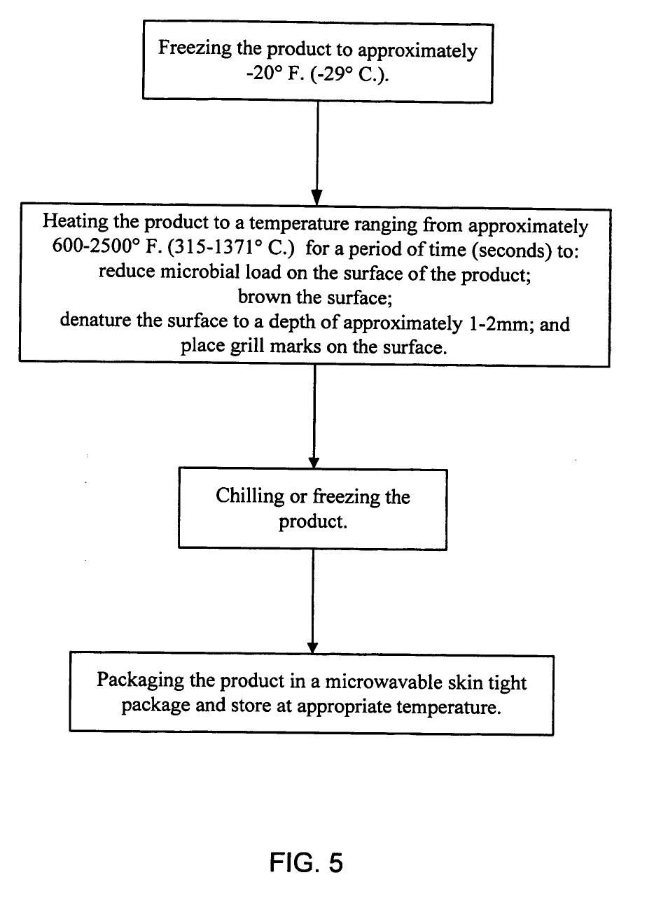

One exemplary embodiment of a method of using the oven 10 to process a product will now be discussed, with reference to FIG. 5. It will be understood that some embodiments of the present disclosure may not include all of the steps depicted in FIG. 5, and that other embodiments may include additional steps beyond those depicted in FIG. 5. It will also be understood that the order of the steps may vary in some embodiments in accordance with the principles of the present disclosure.

A product, such as fish, shellfish, seafood, or any other product desired to be treated or processed may be initially frozen, such as at temperatures of approximately −20° F. (−29° C.), for example. It will be understood that the temperatures referred to herein are for exemplary purposes only, and the temperatures may vary depending on the particular products involved. The presently disclosed method does not require thawing the product prior to treatment. However, it will be understood that thawing may be accomplished in some embodiments, and other situations may include products that may not be frozen.

The products may be loaded on the conveyor 32 of the oven 10 and exposed to temperatures in a range of between approximately 600-2500° F. (315-1371° C.), for a short dwell time (seconds) in the chamber 18 to reduce the microbial load on the surface of the products. For example, at a temperature of about 2000° F. (1093° C.) for 100 seconds, the total numbers of microorganisms, on the surface of the product, can be reduced by a factor of 1000 times. Refreshed fish, which may usually spoil in 2-3 days, may have a shelf-life of approximately 15 days after processing, packaging, and storage in accordance with the present disclosure.

Heating the products in the oven 10 may also brown the surface of the products and denature the surface to a depth of approximately 1-2 millimeters. The remainder of the product may remain raw. The barrier formed by the denatured surface may reduce the loss of moisture during cooking resulting in a juicier cooked product. The barrier may also help to prevent damage to the product structure during packaging. Also, the oven temperatures and dwell times may denature the surface and form the barrier so quickly that little or no protein exudation may be evident on a surface of the product after the ultra high temperature treatment. Moreover, the heating process may be used to place grill marks on the surface to impart a charcoal flavor that may remain with the product once the product is finally cooked.

The products leaving the oven 10 may then be chilled or frozen at a suitable temperature. The products having been processed may have a greatly reduced microbial load such that contamination of adjacent processing systems may be greatly reduced. Accordingly, improved cleaning, chilling, treating, or packaging systems adjacent to the oven 10 may be possible. For example, the exit of the oven 10 may be adjacent to a sterile packaging room, such that products such as fish portions can continuously enter the packaging area without contaminating the air in the room.

The products may also be packaged, such as in a microwavable or boil-in-the-bag skin tight package. For example, the products may be packaged using systems such as Sealed Air Cryovac® food packaging systems using vacuum skin-packaging that are well known in the art. The products may then stored at an appropriate temperature, such as approximately 34° F. (1° C.) for refreshed products, or approximately −10° F. (−23° C.) for frozen products, for example. It will be understood that some embodiments of the present disclosure may be packaged in any variety of packages, such as those suitable or not suitable for being used in a microwave oven or boiling water bath. Moreover, it will be understood that the products may not be packaged in some embodiments of the present disclosure. The packaged products may be stored in a suitable location, such as a freezer or refrigerator, or the like, until it is desired to fully cook the product.

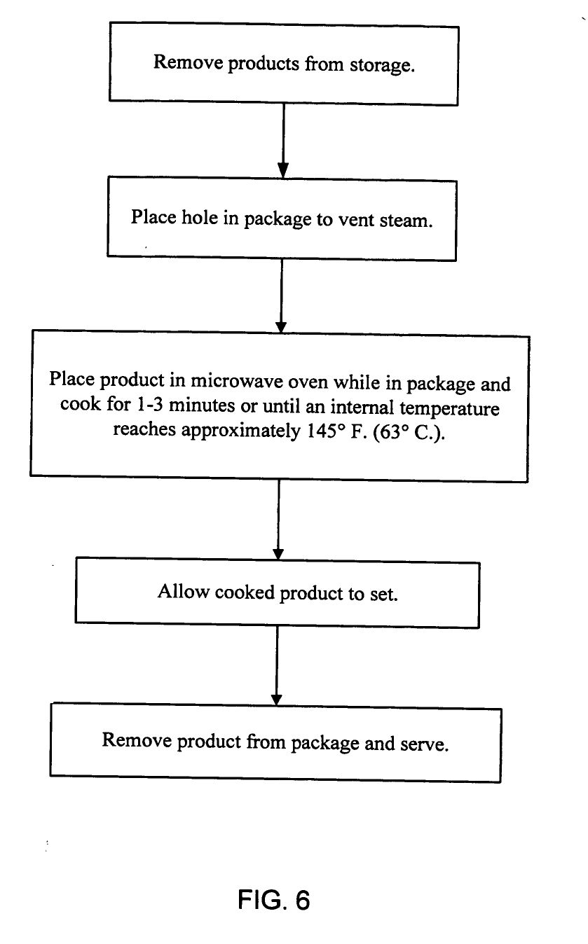

As shown in FIG. 6, which depicts a flow chart of exemplary steps in cooking the product, the product may be removed from storage and a small hole or holes may be made in the package to vent steam as the product is cooked in a microwave oven. The product may be placed in a microwave oven on a typical high setting and cooked for 1-3 minutes depending on the wattage of the oven and the size of the product or cooking for 10-15 minutes using a boiling water bath, until the product reaches an internal temperature of approximately 145° F. (63° C.), for example. The cooked product may be allowed to set for a period of time, such as 30 seconds, or any other suitable time depending on the product. The product may then be removed from the package and served. When the protein barrier is surrounded by a skin tight microwavable packaging film and cooked in the film, even greater moisture retention may be evident to observers. No warmed over flavors may be evident in the cooked products since the products may be cooked from a raw condition rather than a precooked condition. It will be understood, however, that the products may alternatively be cooked using a conventional stove or oven within the scope of the present disclosure.

The principles of the present disclosure may provide consumers with products such as raw fish and shellfish that have a grilled appearance, a charcoal flavor, and a juicy, firm, flaking texture. The products can be ready to place on the table for consumption in less than four minutes using microwave technology or 10-15 minutes using a boiling water bath. No thawing may be necessary. The advantages to the consumer purchasing these products may also include a reduction in preparation time. The products may be removed from the refrigerator or freezer, placed in the microwave or boiling water bath for a brief set time, and be ready to eat in minutes. The present method may be capable of producing cooked food products with consistent results. The present disclosure may also provide a reduction in cooking time as the products may already be browned and have a charcoal flavor. Clean-up may also be simplified, as the packaging may simply be discarded. The food products may have a consistent color and flavor, and all surfaces of the product may receive the same application of heat. The product may have a juicier texture with little or no protein exudates. Moreover, it will be understood that the shelf-life for refreshed portions may be extended. Also, cooking products produced in accordance with the present disclosure may not require a high level of skill. Still further, the packaging useful in accordance with the present disclosure, such as skin tight packaging, may allow the consumer to visually examine both the refrigerated and frozen portions. More importantly however, the end user no longer has to handle raw seafood and risk cross-contamination, which is a major food safety issue.

In accordance with the features and combinations described above, a useful method of processing a product includes the steps of:

placing the product in a chamber to heat a surface of the product while maintaining an interior of the product raw;

heating the chamber with a heat source on an exterior of the chamber;

removing the product from the chamber and enclosing the product in a package such that the product can be cooked in the package.

Those having ordinary skill in the relevant art will appreciate the advantages provide by the features of the present disclosure. For example, it is a feature of the present disclosure to provide an oven that is relatively simple in design and manufacture. Another feature of the present disclosure is to provide such an oven that may consistently produce products of uniform quality. It is an additional feature of the present disclosure to provide an oven that is particularly well suited for use with fish and shellfish, though it will be understood that similar advantages may be applicable to other products in addition to fish and shellfish within the scope of the present disclosure.

It is another feature of the present disclosure to provide an oven and method for processing food products in which fish and shellfish portions may be seared from an indirect source of heat so that uniform heat may be applied to all the surfaces of each portion.

It is an additional feature of the present disclosure to provide an oven and method for processing food products in which the speed with which the portions move through the hot zone of the oven may be controlled by the operator.

It is another feature of the present disclosure to provide an oven and method for processing food products in which oven temperature can be controlled by thermostat so that a constant temperature can be maintained at any suitable level.

A further feature of the present disclosure is to provide an oven and method for processing food products in which the microbial load on surfaces of the products may be significantly reduced, thus extending the shelf-life of the products.

Another feature of the present disclosure is to provide an oven and method for processing food products in which browning of the products, such as fish, may be uniform, hence eye appeal may be enhanced.

It is an additional feature of the present disclosure to provide an oven and method for processing food products in which intensity of grill marking can be controlled so as to vary the intensity of charcoal flavor.

An additional feature of the present disclosure is to provide an oven and method for processing food products in which browning and grill marking may provide color and flavor so the products can be cooked in a microwave oven, yet have the appearance and quality of a grilled product.

It is another feature of the present disclosure to provide an oven and method for processing food products in which the exit of the oven may be adjacent to a sterile packaging room, such that products such as fish portions can continuously enter the packaging area without contaminating the air in the room.

It is an additional feature of the present disclosure to provide an oven and method for processing food products in which the temperature of the belt can be controlled so as to effectively grill-mark sides of the product and prevent sticking.

Another aspect of the present disclosure is to provide an oven and method for processing food products in which the hot zone of the chamber may remain at a constant temperature when the conveyor carries a maximum load, such as 900 pounds per hour.

It is another feature of the present disclosure to provide an oven and method for processing food products in which the oven temperature and dwell time can be controlled simultaneously to effectively process different species and portion sizes.

It is another feature of the present disclosure to provide an oven and method for processing food products in which oven temperatures and dwell times may not cook the products such as fish portions, or burn the surface of the products.

Another aspect of the present disclosure is to provide an oven and method for processing food in which the denaturing of protein and barrier formation at the surface of the products, such as fish portions, may prevent damage to the product structure during packaging.

It is another feature of the present disclosure to provide an oven and method for processing food products in which oven temperatures and dwell times may denature the surface and form a barrier so quickly that no protein exudation may be evident on a surface of the product after ultra high temperature treatment.

The oven design may have unique features in that the oven may provide a mechanism to reach a uniform temperature high enough (600-2500° F.) to minimize denaturing of protein while browning the surface typical of a grilled appearance.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function, and manner of operation, assembly and use may be made without departing from the principles and concepts set forth herein.

What is claimed is:

1. A method of processing a product, the method comprising:
placing the product in a chamber to heat a surface of the product while maintaining an interior of the product raw;
heating the chamber with a heat source on an exterior of the chamber;
removing the product from the chamber and enclosing the product in a package such that the product can be cooked in the package.

2. The method of claim 1, wherein the product is initially frozen.

3. The method of claim 2, wherein the product is frozen to approximately −20° F.

4. The method of claim 1, wherein the product is exposed to a temperature within a range of about 600° F. to about 2500° F. in the oven.

5. The method of claim 1, wherein the product is heated to denature surface proteins of the product.

6. The method of claim 5, wherein the surface of the product is denatured to a depth of no greater than approximately 2 mm.

7. The method of claim 1, wherein the product is heated to denature a surface of the product to a depth ranging from approximately 1 mm to approximately 2 mm.

8. The method of claim 1, wherein the product is heated to reduce microbial load on the surface of the product.

9. The method of claim 1, wherein the product is heated to brown a surface of the product.

10. The method of claim 1, further comprising placing grill marks on a surface of the product to impart a grilled appearance to said product.

11. The method of claim 1, further comprising chilling the product.

12. The method of claim 1, further comprising freezing the product.

13. The method of claim 1, wherein the package is a skin tight microwavable package.

14. The method of claim 1, further comprising storing the packaged product at a temperature of approximately 34° F.

15. The method of claim 1, further comprising storing the packaged product at a temperature of approximately −20° F.

16. The method of claim 1, further comprising forming an opening in the package.

17. The method of claim 16, further comprising configuring said product to be cooked in said package in a microwave oven.

18. The method of claim 17, further comprising cooking said product for a time between a range of approximately 1 to 3 minutes.

19. The method of claim 17, further comprising cooking said product until an internal temperature of said product reaches approximately 145° F.

20. The method of claim 1, wherein said product comprises fish or shellfish.

21. A method of processing a product, said method comprising:
placing the product on a circulating belt of a conveyor to carry the product through an oven;
cleaning the belt as the belt circulates;
heating a surface of the product in the oven to denature surface proteins of the product while maintaining an interior of the product raw; and
enclosing the product in a package after the product exits the oven such that the product can be cooked in the package.

22. The method of claim 21, wherein cleaning the belt as the belt circulates comprises passing the belt through a tank containing a cleaning agent.

23. The method of claim 21, wherein cleaning the belt as the belt circulates comprises contacting the belt with a brush.

24. The method of claim 21, wherein the product is exposed to a temperature within a range of about 600° F. to about 2500° F. in the oven.

25. The method of claim 21, wherein the surface of the product is denatured to a depth of no greater than approximately 2 mm.

26. The method of claim 21, further comprising placing grill marks on a surface of the product to impart a grilled appearance to the product.

27. The method of claim 1, wherein the package is a skin tight microwavable package.

28. The method of claim 1, wherein the product is initially frozen;
wherein the product is frozen to approximately −20° F.;
wherein the product is exposed to a temperature within a range of about 600° F. to about 2500° F. in the oven;
wherein the product is heated to denature surface proteins of the product;
wherein the surface of the product is denatured to a depth of no greater than approximately 2 mm;
wherein the product is heated to denature a surface of the product to a depth ranging from approximately 1 mm to approximately 2 mm;
wherein the product is heated to reduce microbial load on the surface of the product;
wherein the product is heated to brown a surface of the product;
further comprising placing grill marks on the surface of the product with a brander to impart a grilled appearance to said product;
wherein the package is a skin tight microwavable package;
further comprising configuring said product to be cooked in said package in a microwave oven;
wherein said product comprises fish or shellfish;
wherein placing the product in a chamber comprises placing the product on a circulating belt of a conveyor to carry the product through the chamber;
cleaning the belt as the belt circulates;
wherein cleaning the belt as the belt circulates comprises passing the belt through a tank containing a cleaning agent;
wherein cleaning the belt as the belt circulates comprises contacting the belt with a brush;
adjusting a position of the brander with respect to an entrance of the oven to adjust an intensity of the grill marks on the products;
defining an enclosed space having an outlet located at a lower portion of the enclosed space;
providing the chamber in the enclosed space;
heating the chamber with the heat source in the enclosed space; and
removing exhaust from the outlet.

29. A method of processing a product, said method comprising:
placing the product in an oven, the oven having an entrance;
placing grill marks on the product with a brander;
adjusting a position of the brander with respect to the entrance to adjust an intensity of the grill marks on the products.

30. The method of claim 29, further comprising heating a surface of the product while maintaining an interior of the product raw.

31. The method of claim 30, wherein the surface of the product is denatured to a depth of no greater than about 2 mm.

32. The method of claim 29, further comprising enclosing the product in a package such that the product can be cooked in the package.

33. The method of claim 32, wherein the package is a skin tight microwavable package.

34. The method of claim 29, further comprising placing the product on a circulating belt of a conveyor to carry the product through the oven.

35. The method of claim 34, further comprising passing the belt through a tank to clean the belt as it circulates.

36. A method of processing a product, said method comprising:
defining an enclosed space having an outlet located at a lower portion of the enclosed space;
providing a chamber in the enclosed space;
heating the chamber with a heat source in the enclosed space;
removing exhaust from the outlet; and
placing the product in the chamber.

37. The method of claim 36, wherein the product is heated to denature a surface of the product to a depth of no greater than approximately 2 mm.

38. The method of claim 36, further comprising placing grill marks on a surface of the product to impart a grilled appearance to said product.

39. The method of claim 36, further comprising placing the product on a circulating belt of a conveyor to carry the product through the chamber.

40. The method of claim 39, further comprising cleaning the belt as the belt circulates.

41. An oven for processing products, said oven comprising:
a chamber for receiving said products;
a conveyor comprising a belt for carrying said products, said belt passing through said chamber;
a heat source for heating said chamber; and
a tank for receiving a cleaning agent;
wherein said belt passes through said tank for cleaning said belt.

42. The oven of claim 41, further comprising at least one brander for placing grill marks on the products.

43. The oven of claim 42, wherein the at least one brander comprises a top brander for placing grill marks on upper surfaces of the products, and a bottom brander for placing grill marks on lower surfaces of the products.

44. The oven of claim 42, wherein the at least one brander comprises an elongate wheel comprising a plurality of rods extending across the belt.

45. The oven of claim 41, further comprising at least one brush for brushing said belt to clean said belt as said belt travels.

46. The oven of claim 41, wherein said chamber is defined by a chamber wall.

47. The oven of claim 46, further comprising an enclosure defining an enclosed space.

48. The oven of claim 47, wherein said chamber wall passes through said enclosed space.

49. The oven of claim 48, wherein said heat source is positioned in said enclosed space on an exterior of said chamber wall such that heat from said heat source encompasses said chamber wall to heat said chamber wall to provide radiant heat inside said chamber.

50. An oven for processing products, said oven comprising:
a chamber for receiving said products;
a conveyor comprising a belt for carrying said products, said belt passing through said chamber;
a heat source for heating said chamber; and
at least one brander for placing grill marks on the products;
wherein a position of said at least one brander is adjustable to vary an intensity of the grill marks on the products.

51. The oven of claim 50, wherein the at least one brander comprises a top brander for placing grill marks on upper surfaces of the products, and a bottom brander for placing grill marks on lower surfaces of the products.

52. The oven of claim 50, wherein the at least one brander comprises an elongate wheel comprising a plurality of rods extending across the belt.

53. The oven of claim 50, wherein movement of said belt operates to rotate the brander.

54. The oven of claim 50, wherein said at least one brander is adjustable toward an entrance of the oven to decrease the intensity of the grill marks, and away from the entrance inside the chamber to increase the intensity of the grill marks on the products.

55. The oven of claim 50, further comprising a tank for receiving a cleaning agent, wherein said belt passes through said tank for cleaning said belt.

56. The method of claim 32, wherein the package is a skin tight boil-in-the-bag package.

57. The method of claim 1, wherein the product is initially frozen;
wherein the product is frozen to approximately −20° F.;
wherein the product is exposed to a temperature within a range of about 600° F. to about 2500° F. in the oven;
wherein the product is heated to denature surface proteins of the product;
wherein the surface of the product is denatured to a depth of no greater than approximately 2 mm;
wherein the product is heated to denature a surface of the product to a depth ranging from approximately 1 mm to approximately 2 mm;
wherein the product is heated to reduce microbial load on the surface of the product;
wherein the product is heated to brown a surface of the product;
further comprising placing grill marks on the surface of the product with a brander to impart a grilled appearance to said product;
wherein the package is a skin tight boil-in-the-bag package;
further comprising configuring said product to be cooked in said package in a boiling water bath;
wherein said product comprises fish or shellfish;
wherein placing the product in a chamber comprises placing the product on a circulating belt of a conveyor to carry the product through the chamber;
cleaning the belt as the belt circulates;
wherein cleaning the belt as the belt circulates comprises passing the belt through a tank containing a cleaning agent;
wherein cleaning the belt as the belt circulates comprises contacting the belt with a brush;
adjusting a position of the brander with respect to an entrance of the oven to adjust an intensity of the grill marks on the products;
defining an enclosed space having an outlet located at a lower portion of the enclosed space;
providing the chamber in the enclosed space;
heating the chamber with the heat source in the enclosed space; and
removing exhaust from the outlet.

58. The method of claim 1, wherein the package is a skin tight boil-in-the-bag package.

59. A method of processing a product, the method comprising:
placing the product in a chamber to heat a surface of the product while maintaining an interior of the product raw;
heating the chamber with a heat source on an exterior of the chamber;
removing the product from the chamber and enclosing the product in a package such that the product will not be exposed to cross contamination.
